(19) United States
(12) Patent Application Publication
(10) Pub. No.: US 2026/0176137 A1
(43) Pub. Date: Jun. 25, 2026

(54) METHOD AND SYSTEM FOR SYNTHESIZING METHANOL

(71) Applicant: GASCONTEC GMBH, Bad Homburg v. d. Höhe (DE)

(72) Inventors: Wolfgang LAUER, Schwalmstadt (DE); Dierk MÜLLER, Karben (DE); Dorit RAPPOLD, Frankfurt (DE); Ulrich WAGNER, Bernburg (DE)

(21) Appl. No.: 18/725,917

(22) PCT Filed: Jan. 16, 2023
(86) PCT No.: PCT/EP2023/050882

§ 371 Date: Jul. 1, 2024

(30) Foreign Application Priority Data
Jan. 17, 2022 (EP) 22151780.8

(51) Int. Cl. C01B 3/56; B01D 53/047; B01D 53/14; B01J 8/04; C01B 3/48

(52) U.S. Cl. CPC C01B 3/56; B01D 53/047; B01D 53/1425; B01J 8/0492; B01J 8/0496; C01B 3/48; C01B 2203/0233; C01B 2203/0283; C01B 2203/043; C01B 2203/061; C01B 2203/1241

(57) ABSTRACT

A method for synthesizing methanol and a synthesis gas flow include supplying hydrogen and carbon oxides to a methanol reactor assembly. A residual gas flow with unreacted hydrogen and unreacted carbon oxides is obtained from the methanol reactor assembly, and the residual gas flow is supplied to a hydrogen separation assembly to obtain a hydrogen-containing flow, which is supplied to the methanol reactor assembly and has a higher molar proportion of hydrogen than the residual gas flow. A purge gas flow having methane is obtained from the hydrogen separation assembly. The purge gas flow is supplied to a recovery assembly for recovering a recovery flow having carbon dioxide and hydrogen, the recovery assembly has a recovery reactor for partly converting the methane of the purge gas flow into carbon oxides and hydrogen using a partial thermal oxidation, and the recovery flow is supplied to the methanol reactor assembly.

### CROSS-REFERENCE TO RELATED APPLICATIONS

This application is a 35 U.S.C. § 371 National Stage patent application of PCT/EP2023/050882, filed on 16 Jan. 2023, which claims the benefit of European patent application 22151780.8, filed on 17 Jan. 2022, the disclosures of which are incorporated herein by reference in their entirety.

### TECHNICAL FIELD

The disclosure relates to a method for synthesizing methanol, and to a plant for synthesizing methanol.

### BACKGROUND

An increasingly important aspect in the synthesis of methanol is the reduction or prevention of emissions, in particular of carbon dioxide in the course of methanol synthesis. Significant differences exist even in the prior art depending on the type of technology used for synthesizing methanol. For example, a methanol plant operated with an Autothermal Reformer (ATR) for generating synthesis gas, such as is described for example in EP 3 205 622 Bl, considered to be the closest prior art, is associated with only 40% of the carbon dioxide emissions compared with other methanol plant types such as the steam reformer.

The major reasons for these, as noted, already relatively low carbon dioxide emissions, are the combustion of exclusively natural gas and purge gas to operate heat exchangers for superheating steam and preheating natural gas, and the need to introduce additional hydrogen to balance the synthesis gas, which is typically substoichiometric during autothermal reforming. Superheated steam is typically needed to run turbines, which in turn drive the compressors.

In the light of this situation, therefore, in principle the remaining carbon dioxide emissions might also be largely eliminated if firstly the heat exchangers are powered by electricity, using climate-neutral energy sources, and secondly if an additional water electrolysis is also carried out to obtain said hydrogen with electrical r from climate-neutral energy sources.

However, even if these measures are implemented, one persistent problem remains: that of what is to be done with the purge gas, which henceforth cannot be combusted in the heat exchangers. On the one hand, the occasionally substantial nitrogen fraction already in the fresh gas forces the need to separate the nitrogen out of the methanol synthesis circuit, as otherwise the total volume of gas in the synthesis circuit increases excessively, which in turn demands an increase in the dimensioning of the plant, and in particular of the energy-intensive compressors, and in the event of absolute non-separation, leads to the breakdown of the plant. On the other hand, the content of both carbon dioxide and methane in the purge gas is too high for it to be possible to simply combust the purge gas or otherwise discharge it into the atmosphere without failing to comply with the desired reduction in carbon dioxide emissions.

### SUMMARY

Given this background, the disclosure therefore comprises providing an approach for synthesizing methanol that enables an economically viable operation largely fee from carbon dioxide emissions, wherein the carbon dioxide that is no longer emitted is converted into methanol.

With regard to a method for synthesizing methanol having the features of first independent claim, this is solved by providing the features set forth in the independent claims. With regard to a system for synthesizing methanol, this is solved with the features set forth in the independent claims.

The disclosure is based on the realisation that a purge gas flow that is removed from the synthesis circuit can be processed with the object of carbon dioxide neutrality by directing said purge gas flow to a reactor for partial thermal oxidation. Because the result achieved with partial thermal oxidation is that of converting the methane contained in the purge gas flow into carbon oxides and hydrogen. By this method, a distinct separation both of the carbon oxides and the hydrogen from the purge gas flow is then possible. After this separation, typically only nitrogen and noble gas fractions remain in a residual gas flow, which means that this residual gas flow can be discharged into the surrounding atmosphere without any climate-harming carbon dioxide or any hydrogen, which in and of itself is valuable for synthesizing methanol. The separated carbon dioxide and the separated hydrogen in turn can be returned to the methanol synthesizing circuit and thus enable the carbon dioxide, which would otherwise be emitted into the atmosphere, to be converted into methanol.

The claims describe an advantageous option for converting the carbon monoxide from the purge gas flow into carbon dioxide after the partial oxidation, so that it can easily be removed from the purge gas flow. The claims describe an advantageous option for removing the carbon dioxide as completely as possible from the purge gas containing no carbon monoxide.

The dependent claims then relate to variants for the recovery of the maximum possible hydrogen from the purge gas flow.

A carbon dioxide-neutral option for operating the heat exchangers, and corresponding options for operating a synthesis gas compressor are described in the dependent claims.

A reactor design which is efficient precisely for substoichiometric synthesis gas for methanol synthesis is set forth in the claims.

Finally, claims provide for the supply of in particular climate-neutrally obtained hydrogen in order to adjust the stoichiometry.

Preferred variants, features and advantages of the method according to the disclosure for synthesizing methanol are equivalent to preferred variants, features and advantages of the system according to the disclosure for synthesizing methanol and vice versa.

### BRIEF DESCRIPTION OF THE DRAWING

Further details, features, and advantages of the present disclosure will be explained in the following text with reference to a drawing representing a single exemplary embodiment. In the drawing

FIG. 1 Shows a diagrammatic representation of an exemplary embodiment of the suggested system for synthesizing methanol for carrying out the suggested method for synthesizing methanol.

### DETAILED DESCRIPTION OF THE DISCLOSURE

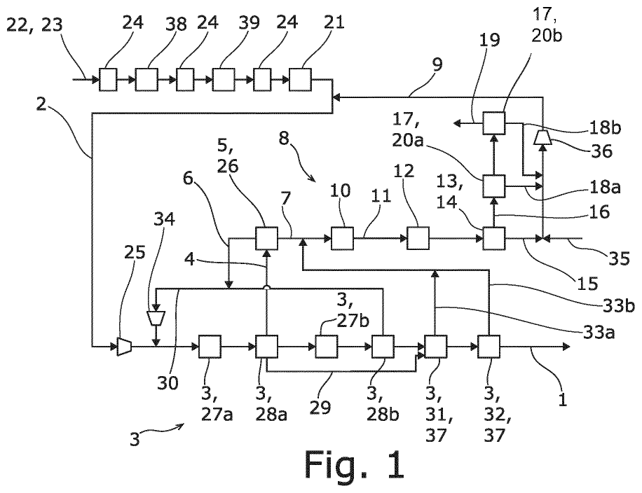

The suggested method for synthesizing methanol 1 may be performed by the suggested system for synthesizing methanol 1 in accordance with the exemplary embodiment of FIG. 1.

In the suggested method for synthesizing methanol 1, a synthesis gas flow 2 comprising hydrogen and carbon oxides is supplied to a methanol reactor assembly 3 of the suggested system for synthesizing methanol 1. In particular, it may be that the synthesis gas flow 2 has a molar proportion of hydrogen of at least 50% or at least 60%, alternatively or additionally a molar proportion of carbon dioxide of at least 5% and/or not more than 10%, alternatively or additionally a molar proportion of carbon monoxide of at least 15% and/or not more than 30% and alternatively or additionally a molar proportion of methane of at least 1% and/or not more than 5%.

In addition, in the suggested method a residual gas flow 4 with unreacted hydrogen and unreacted carbon oxides is obtained from the methanol reactor assembly 3, which residual gas flow 4 is supplied to a hydrogen separation assembly 5 of the system according to the suggestion in order to obtain a hydrogen-containing flow 6, wherein the hydrogen-containing flow 6 is supplied to the methanol reactor assembly 3 and has higher molar proportion of hydrogen than the residual gas flow 4. At this point, the residual gas flow 4 preferably has a molar proportion of hydrogen of at least 60% and in particular of at least 70%. The molar proportion of carbon oxides in the residual gas flow 4 is preferably at least 5% and/or not more than 15%. The molar proportion of methane in the residual gas flow 4 is preferably at least 10% and/or not more than 25%. The molar proportion of nitrogen in the residual gas flow 4 is preferably not more than 10%.

Finally, in the suggested method a purge gas flow 7 comprising methane is obtained from the hydrogen separation assembly 5. Besides methane, the purge gas flow 7 may include other constituents. It may be that the purge gas flow 7 includes carbon dioxide, carbon monoxide, nitrogen and argon, and in particular consists of these constituents. The purge gas flow 7 preferably comprises a molar proportion of hydrogen of not more than 50%, in particular not more than 40%. It is also preferred that the combined molar proportion of carbon dioxide and carbon monoxide in the purge gas flow 7 is not more than 30%. It may be that the purge gas flow 7 includes a molar proportion of methane of at least 15% or at least 20%. Finally, it may be that the purge gas flow 7 comprises a molar proportion of nitrogen of at least 5% and/or not more than 30%. The molar proportion of argon in the purge gas flow 7 is preferably at least 0.1% and not more than 5%.

The method according to the suggestion is characterized in that the purge gas flow 7 is supplied to a recovery assembly 8 of the suggested system for recovering a recovery gas flow 9 comprising carbon dioxide and hydrogen, that the recovery assembly 8 includes a recovery reactor 10 for at least partly, preferably substantially completely converting the methane of the purge gas flow 7 into carbon oxides and hydrogen by means of partial thermal oxidation, and that the recovery gas flow 9 is supplied to the methanol reactor assembly 3. The recovery gas flow 9 may specifically be obtained from the recovery reactor 10. However, it may also be that the recovery gas flow 9—as described hereafter—is obtained from a further processing of a flow obtained from the recovery reactor 10. Here and in the following text, the term partial thermal oxidation is understood to mean partial oxidation without a catalytic medium. The partial thermal oxidation may therefore also be described as partial non-catalytic oxidation. The partial thermal oxidation preferably takes place at a temperature of at least 1200° C. Ultimately, the carbon dioxide and the hydrogen are supplied to the methanol synthesizing process. Due to the conversion of the methane in the recovery reactor 10, apart from carbon oxides only nitrogen and argon remain as residual substances in significant quantities, that is to say precisely those substances whose removal from the synthesis circuit is desired.

Regarding the recovery gas flow 9, it is preferred that—upon being supplied to the methanol reactor assembly 3—it comprises a molar proportion of hydrogen of at least 70% and/or a molar proportion of carbon dioxide of at least 20%.

In principle, there are no limitations on the way in which the converted carbon oxides and the hydrogen are introduced into the recovery gas flow 9 or processed further for this purpose. Preferably, a product flow 11 recovered from the recovery reactor 10 containing carbon monoxide is supplied to a shift apparatus 12 of the recovery assembly 8 for conversion of the carbon monoxide into carbon dioxide by a water-gas shift reaction. The product flow 11 preferably comprises a molar proportion of carbon monoxide of at least 20% or at least 25%. On the other hand, the molar proportion of carbon dioxide in the product flow 11 is not more than 15% or not more than 10%.

In principle, any quantity or any proportion of the carbon monoxide in the product flow 11 may be converted into carbon dioxide in the shift apparatus 12. Preferably, a molar proportion of carbon monoxide in the product flow 11 is reduced by at least 90% by the water-gas shift reaction. Accordingly, the molar proportion of carbon monoxide in the product flow after the 11 water-gas shift reaction is preferably not more than 1%. On the other hand, the molar proportion of carbon dioxide in the product flow 11 after the water-gas shift reaction is preferably at least 20%. Carbon dioxide is easier to remove from a process flow than carbon monoxide, so that the recovery of the carbon in the form of carbon dioxide for methanol synthesis is made easier.

In principle, the recovery assembly 8 may comprise any other components. The recovery assembly 8 preferably includes a carbon dioxide scrubber 13 for washing out carbon dioxide, and at least of some the washed out carbon dioxide, preferably substantially all of the washed out carbon dioxide, is the recovery included in gas flow 9. In particular, it may be that the carbon dioxide scrubber 13 is designed to wash carbon dioxide out of the product flow 11. The carbon dioxide scrubber 13 is preferably located downstream of the shift apparatus 12 in the process sequence. In principle, the carbon dioxide scrubber 13 may wash the carbon dioxide out by any method. Here it is preferred that the carbon dioxide scrubber 13 has a cold methanol loop (CML) 14 for washing out the carbon dioxide. It is preferred that a carbon dioxide-containing flow 15, which in particular consists predominantly of carbon dioxide is obtained from the carbon dioxide scrubber 13. The molar proportion of the carbon dioxide in the carbon dioxide containing flow is preferably at least 50%, in particular at least 90%.

This carbon dioxide-containing flow 15 comprises the washed out carbon dioxide. The removal of the carbon dioxide—and through the prior conversion of the carbon monoxide, therefore of the carbon oxides in total—makes a subsequent recovery of the hydrogen while simultaneously separating the residual substances nitrogen and argon out of the product flow 11 much easier, as will be described in the following text.

It is further preferred that a further residual gas flow 16 is obtained from the carbon dioxide scrubber 13 and supplied to a hydrogen recovery assembly 17 for obtaining a further hydrogen-containing flow 18a, b and a flue gas flow 19. Here it is preferred that a molar proportion of hydrogen in the hydrogen-containing flow 18a, b is greater than in the residual gas flow 16. The further residual gas flow 16 preferably comprises a molar proportion of hydrogen of at least 90% and/or a molar proportion of nitrogen of at least 3%. The further hydrogen-containing flow 18a, b preferably consists substantially of hydrogen.

The flue gas flow 19 preferably comprises nitrogen and argon. The flue gas flow 19 may further contain residual quantities of hydrogen, methane and carbon oxides. It is preferred that a molar proportion of at least 30% of the flue gas flow 19 is constituted by nitrogen and argon. In particular, it may be that the molar proportion of nitrogen in the flue gas flow 19 is at least 30%.

It is further preferred that at least some of the hydrogen in the hydrogen-containing flow 18a, b is comprised by the recovery gas flow 9. This may be achieved in particular by arranging that the recovery gas flow 9 is formed at least in part by the hydrogen-containing flow 18a, b.

In principle, the hydrogen recovery assembly 17 may be of any design and configuration. The hydrogen recovery assembly 17 preferably includes a pressure swing adsorption (PSA) recovery apparatus 20a, b for obtaining the further hydrogen-containing flow 18a, b and the flue gas flow 19.

Ideally, the hydrogen recovery assembly 17 only includes a pressure swing adsorption recovery apparatus 20a, b. However, in order to further minimise hydrogen losses, it is advantageous if the hydrogen recovery assembly 17 includes a multitude of pressure swing adsorption (PSA) recovery apparatuses 20a, b arranged one after the other in the process sequence to obtain respective further hydrogen-containing flows 18a, b and the flue gas flow 19. The further hydrogen-containing flows 18a, b preferably consist substantially of hydrogen.

In principle, the synthesis gas flow 2 may be of any origin. It is preferred that a carbon-containing energy source flow 22 is supplied to a synthesis gas reactor 21 to obtain the synthesis gas flow 2. In particular, it may be that the carbon-containing energy source flow 22 comprises a natural gas flow 23 or consists substantially of the natural gas flow 23. In particular, it may be that the system according to the suggestion comprises the synthesis gas reactor 21.

It is preferable that the synthesis gas flow 2 is fed to a desulphurisation and saturation assembly 38 and a prereformer 39 before being supplied to the synthesis gas reactor 21, which are included in the suggested system.

It is typically advantageous or necessary to heat the energy source flow 22 before it is supplied to the synthesis gas reactor 21. In principle, this may be carried out in any way. It is preferred that the energy source flow 22 is preheated by an electrically operated heater assembly 24 before it is supplied to the synthesis gas reactor 21. Unlike heating in heat exchangers fired by natural gas, no carbon dioxide is released when heating in this way. It is further preferred that the heater assembly 24 is operated with climate-neutrally obtained electrical power. The suggested system preferably comprises the heater assembly 24. The heater assembly 24 may consist of a single heating apparatus. However, as illustrated in FIG. 1, the heater assembly 24 may also comprise a multitude of heating apparatuses. Said heating apparatuses of the heater assembly 24 may be arranged upstream of each of the desulphurisation and saturation assembly 38, the prereformer 39 and the synthesis gas reactor 21 in the process sequence.

Each of the heating apparatuses represented may in turn consist of a plurality of individual apparatuses. Accordingly, it is further preferred that at least one heating apparatus of the heater assembly 24 consists of a cascade of single heating units. This is advantageous because the temperature increase that can be reached by a single electrically operated heating unit is typically limited to a value lower than the overall temperature increase sought.

In principle, the synthesis gas reactor 21 may be any type of reactor suitable for generating synthesis gas. It is preferred that the synthesis gas flow 2 is obtained in the synthesis gas reactor 21 by autothermal reforming, in the course of which a partial catalytic oxidation provides the necessary heat for the endothermic steam reforming reactions. It is further preferred that the synthesis gas flow 2 obtained in the synthesis gas reactor 21 has a molar ratio, expressed by

$$S = \frac{n ( {H}_{2} ) - n ( {CO}_{2} )}{n ( CO ) + n ( {CO}_{2} )} ,$$

of S<2. In particular, it may be that the molar ratio is S<1.8. The synthesis gas flow 2 is then substiochiometric and has a hydrogen deficit that is favourable for synthesizing methanol.

Specifically with regard to the production of synthesis gas by autothermal reforming, the synthesis flow is 2 prepared with a pressure lower than is needed for synthesizing methanol. Therefore, it is preferred that the synthesis gas flow 2 is pressurised by a gas compressor 25 before it is supplied to the methanol reactor assembly 3. The synthesis gas flow 2 is preferably pressurised by the gas compressor 25 to a pressure of at least 70 bara before being fed to the methanol reactor assembly 3.

A first preferred option consists in that the synthesis gas compressor 25 is operated electrically, and in particular by climate-neutrally generated electrical power. Climate-neutrally generated electrical power is preferably obtained by nuclear power and/or from regenerative energy sources. In this way, the synthesis gas compressor 25 may thus be operated without the need to generate steam for a steam turbine by combustion of purge gas.

However, a climate-neutral drive is still possible when a steam turbine is used to run the synthesis gas compressor 25. Thus, in fact, a second preferred option provides that the synthesis gas compressor 25 is powered by a steam turbine operated with high-pressure steam, wherein the high-pressure steam is preferably superheated electrically, and in particular with climate-neutrally obtained electricity.

Ideally, the high-pressure steam is produced in the course of the methanol synthesis process.

In principle, the hydrogen separation assembly 5 may have any form. The hydrogen separation assembly 5 preferably includes a pressure swing adsorption (PSA) separation apparatus 26 for obtaining the hydrogen-containing flow 6 and the purge gas flow 7. In particular, it may be that the hydrogen-containing flow 6 consists substantially of hydrogen.

In principle, the methanol reactor assembly 3 may include any number of individual methanol reactors of various types, which in turn may generally be arranged in parallel or in series without limitation in the process sequence. It is preferred that the methanol reactor assembly 3 includes a first methanol reactor 27a for synthesizing methanol 1, a second methanol reactor 27b for synthesizing methanol 1 arranged downstream of the first methanol reactor 27a in the process sequence, and an intermediate condensation stage 28a arranged between the first methanol reactor 27a and the second methanol reactor 27b in the process sequence for separating raw methanol 29 and obtaining the residual gas flow 4. The raw methanol 29 is the basis for obtaining the methanol 1. Specifically, the methanol 1 comprises the raw methanol 29. The first methanol reactor 27a and/or the second methanol reactor 27b is/are preferably an isothermal reactor.

The methanol reactor assembly 3 preferably also comprises an intermediate condensation stage 28b downstream of the second methanol reactor 27b in the process sequence for separating raw methanol 29 and obtaining a recycle gas flow 30 with unreacted residual gases.

The unreacted residual gases of the recycle gas flow 30 are preferably supplied again to the methanol reactor assembly 3, and specifically to the first methanol reactor 27a. In this process, the recycle gas flow 30 may optionally be pressurised by a recycle compressor 34, which is preferably included as part of the suggested system. The pressurised recycle gas flow 30 may in particular be merged with the synthesis gas flow 2 downstream of the synthesis gas compressor 25 in the process sequence.

It is preferred that the raw methanol 29 from the first intermediate condensation stage 28a and the second intermediate condensation stage 28b is supplied to a separating assembly 37, preferably comprising a flash drum 31 and a distillation apparatus 32 for obtaining methanol 1. The separation assembly 37 is part of the methanol reactor assembly 3. An offgas flow 33a, b is preferably obtained from the separation assembly 37 and specifically from each of the flash drum 31 and the distillation apparatus 32, and is supplied to the purge gas flow 7.

As was described previously, the hydrogen-containing flow 6 is to be supplied to the methanol reactor assembly 3. This may be done in various ways. According to a first preferred variant, which is represented in FIG. 1, the recycle gas flow 30 is merged with the hydrogen-containing flow 6. This preferably takes place upstream of the recycle compressor 34 in the process sequence. A second preferred variant provides that the hydrogen-containing flow 6 is merged with the synthesis gas flow 2. This preferably takes place upstream of the synthesis gas compressor 25 in the process sequence. The dimensioning of the compressors cited is differs according to the respectively selected variant.

The suggested system preferably comprises the recycle compressor 34. In this context, the supply of the recycle gas flows 30 with the hydrogen-containing flow 6 to the synthesis gas flow 2 preferably takes place downstream of the synthesis gas compressor 25 in the process sequence.

Specifically when generating the synthesis gas flow 2 by autothermal reforming, the synthesis gas of the synthesis gas flow 2 is substiochiometric, that is to say it has a hydrogen deficit. This may be counteracted by supplying hydrogen from a source from outside the synthesis circuit. Accordingly, it is preferred that a hydrogen flow 35 is fed to the recovery assembly 8, wherein at least some of the hydrogen of the recovery gas flow 9 originates from the hydrogen flow 35. It is further preferred that the hydrogen flow 35 is obtained from water electrolysis, wherein it may be in particular that the water electrolysis is powered by climate-neutrally obtained electricity. In this context, the hydrogen flow 35 does not have to consist entirely of hydrogen. It is sufficient that the hydrogen flow 35 consists predominantly or substantially of hydrogen.

It is further preferred that the recovery gas flow 9 is supplied to a recovery gas flow compressor 36 of the recovery assembly 8 for pressurisation. This is particularly expedient because hydrogen is only obtained from water electrolysis at low pressure. Therefore, it is also preferred that the recovery compressor 36 is arranged downstream of the supply of the hydrogen flow 35 to the recovery assembly 8 in the process sequence.

The suggested system serves to synthesize methanol 1 and comprises the methanol reactor assembly 3 for synthesizing methanol 1, the methanol reactor assembly 3 to which the synthesis gas flow 2 with hydrogen and carbon oxides is supplied.

The suggested system also includes the hydrogen separation assembly 5 for obtaining the hydrogen-containing flow 6, the hydrogen separation assembly 5 to which residual gas flow 4 with unreacted hydrogen and unreacted carbon oxides obtained from the methanol reactor assembly 3 is supplied, wherein the hydrogen-containing flow 6 is supplied to the methanol reactor assembly 3 and has a higher molar proportion of hydrogen than the residual gas flow 4, and wherein the purge gas flow 7 with methane is obtained from the hydrogen separation assembly 5.

The suggested system is characterized in that the system includes the recovery assembly 8 for recovering the recovery gas flow 9 with carbon dioxide and hydrogen, to which recovery assembly 8 the purge gas flow 7 is supplied, that the recovery assembly 8 includes the recovery reactor 10 for the at least partial conversion of the methane of the purge gas flow 7 into carbon oxides and hydrogen by partial thermal oxidation, and that the recovery gas flow 8 is supplied to the methanol reactor assembly 3.

1. A method for synthesizing methanol, wherein a synthesis gas flow comprising hydrogen and carbon oxides is supplied to a methanol reactor assembly for synthesizing methanol, wherein a residual gas flow with unreacted hydrogen and unreacted carbon oxides is obtained from the methanol reactor assembly, wherein the residual gas flow is supplied to a hydrogen separation assembly in order to obtain a hydrogen-containing flow, wherein the hydrogen-containing flow is supplied to the methanol reactor assembly and has a higher molar proportion of hydrogen than the residual gas flow, and wherein a purge gas flow comprising methane is obtained from the hydrogen separation assembly, characterized in that the purge gas flow is supplied to a recovery assembly for recovering a recovery flow comprising carbon dioxide and hydrogen, the recovery assembly has a recovery reactor for at least partly converting the methane of the purge gas flow into carbon oxides and hydrogen by means of a partial thermal oxidation, and the recovery flow is supplied to the methanol reactor assembly.

2. The method according to claim 1, whereby a product flow recovered from the recovery reactor containing carbon monoxide is supplied to a shift apparatus of the recovery assembly for conversion of the carbon monoxide into carbon dioxide by a water-gas shift reaction, wherein a molar proportion of carbon monoxide in the product flow is reduced by at least 90% by the water-gas shift reaction.

3. The method according to claim 1, whereby the recovery assembly includes a carbon dioxide scrubber for washing out carbon dioxide, from the product flow, and that at least some of the washed out carbon dioxide is included in the recovery gas flow.

4. The method according to claim 3, whereby a further residual gas flow is obtained from the carbon dioxide scrubber and supplied to a hydrogen recovery assembly for obtaining a further hydrogen-containing flow and a flue gas flow, which comprises nitrogen and argon, wherein at least some of the hydrogen in the hydrogen-containing flow is comprised in the recovery flow.

5. The method according to claim 4, whereby the hydrogen recovery assembly includes a pressure swing adsorption (PSA) recovery apparatus for obtaining the further hydrogen-containing flow and the flue gas flow, wherein the further hydrogen-containing flow comprises hydrogen.

6. The method according to claim 5, whereby the hydrogen recovery assembly includes a multitude of pressure swing adsorption (PSA) recovery apparatuses arranged one after the other in the process sequence to obtain respective further hydrogen-containing flows and the flue gas flow, wherein the further hydrogen-containing flows comprises hydrogen.

7. The method according to claim 1, whereby a carbon-containing energy source flow is supplied to a synthesis gas reactor to obtain the synthesis gas flow, wherein the carbon-containing energy source flow comprises a natural gas flow, comprises the natural gas flow.

8. The method according to claim 7 whereby the energy source flow is preheated by an electrically operated heater assembly before it is supplied to the synthesis gas reactor, wherein the heater assembly is operated by climate-neutrally obtained electrical power.

9. The method according to claim 7, whereby the synthesis gas flow is obtained in the synthesis gas reactor by autothermal reforming, in the course of which autothermal reforming a partial catalytic oxidation provides the necessary heat for the endothermic steam reforming reactions, wherein the synthesis gas flow obtained in the synthesis gas reactor has a molar ratio expressed by
$$S = \frac{n ( {H}_{2} ) - n ( {CO}_{2} )}{n ( CO ) + n ( {CO}_{2} )} ,$$
of S<2.

10. The method according to claim 1, whereby the synthesis gas flow is pressurised by a gas compressor before it is supplied to the methanol reactor assembly, wherein the synthesis gas compressor is operated electrically.

11. The method according to claim 10, whereby the synthesis gas compressor is powered by a steam turbine operated with high-pressure steam, wherein the high-pressure steam is superheated electrically.

12. The method according to claim 1, whereby the hydrogen separation assembly includes a pressure swing adsorption (PSA) separation apparatus for obtaining the hydrogen-containing flow and the purge gas flow, wherein the hydrogen-containing flow comprises hydrogen.

13. The method according to claim 1, whereby the methanol reactor assembly has a first methanol reactor for synthesizing methanol, a second methanol reactor for synthesizing methanol arranged downstream of the first methanol reactor in the process sequence, and an intermediate condensation stage arranged between the first methanol reactor and the second methanol reactor in the process sequence for separating raw methanol and obtaining the residual gas flow.

14. The method according to claim 1, whereby a hydrogen flow is fed to the recovery assembly, wherein at least some of the hydrogen of the recovery gas flow originates from the hydrogen flow, wherein the hydrogen flow is obtained from water electrolysis.

15. A system for synthesizing methanol with a methanol reactor assembly for synthesizing methanol, to which methanol reactor assembly a synthesis gas flow with hydrogen and carbon oxides is supplied, with a hydrogen separation assembly for obtaining a hydrogen-containing flow, to which hydrogen separation assembly a residual gas flow with unreacted hydrogen and unreacted carbon oxides obtained from the methanol reactor assembly is supplied, wherein the hydrogen-containing flow is supplied to the methanol reactor assembly and has a higher molar proportion of hydrogen than the residual gas flow, and wherein a purge gas flow with methane is obtained from the hydrogen separation assembly, characterized in that the system has a recovery assembly for recovering a recovery gas flow with carbon dioxide and hydrogen, to which recovery assembly the purge gas flow is supplied, that the recovery assembly includes a recovery reactor for at least partial conversion of the methane of the purge gas flow into carbon oxides and hydrogen by partial thermal oxidation, and that the recovery gas flow is fed to the methanol reactor assembly.
